(19) United States
(12) Patent Application Publication
(10) Pub. No.: US 2015/0154091 A1
(43) Pub. Date: Jun. 4, 2015

(54) BIOS MAINTENANCE METHOD

(71) Applicants: Inventec Corporation, Taipei City (TW); INVENTEC (PUDONG) TECHNOLOGY CORPORATION, Shanghai (CN)

(72) Inventor: Ting-Ting Chen, Shanghai City (CN)

(73) Assignees: nventec Corporation, Taipei City (TW); INVENTEC (PUDONG) TECHNOLOGY CORPORATION, Shanghai (CN)

(21) Appl. No.: 14/162,346

(22) Filed: Jan. 23, 2014

(30) Foreign Application Priority Data
Nov. 29, 2013 (CN) 201310628296.7

(51) Int. Cl. G06F 11/22

(52) U.S. Cl. CPC G06F 11/2284

(57) ABSTRACT

Disclosed herein is a BIOS (basic input/output system) maintenance method. After a server is powered on, the validity of a first BIOS setting stored in a first memory of the server is determined. If the first BIOS setting is invalid, a BIOS of the server loads a BIOS setting default. The validity of a second BIOS setting stored in a baseboard management control module of the server is also determined. If the second BIOS setting is valid, it is stored into the first memory.

### CROSS-REFERENCE TO RELATED APPLICATIONS

This non-provisional application claims priority under 35 U.S.C. §119(a) on Patent Application No. 201310628296.7 filed in People's Republic of China on Nov. 29, 2013, the entire contents of which are hereby incorporated by reference.

### TECHNICAL FIELD

The present invention relates to server technology, particularly to a BIOS (basic input/output system) maintenance method.

### BACKGROUND

When a server is powered up, its BIOS performs power-on self-test (POST) for it to initialize the swarm of components on the motherboard and provide the necessary runtime environment for the operating system. It is required prior to the initialization that the BIOS load its setting, which may include the boot device sequence or whether some specific function should be enabled on the motherboard. Inability of the BIOS, an essential firmware, to access a correct setting will completely paralyze the server, and in practice settings can be damaged, lost, or become incompatible with the BIOS in a variety of ways, e.g. due to an execution error of the BIOS or a change in format after a version update.

### SUMMARY

In light of the above, the present invention discloses a method for maintaining BIOS, taking advantage of the fact that the baseboard management control module of the Intelligent Platform Management Interface (IPMI) is independent from the central processing unit (CPU).

In the BIOS maintenance testing method provided by this disclosure, a server is first started up, and the validity of a first BIOS setting stored in a first memory of the server is determined. A BIOS of the server loads a BIOS setting default when the first BIOS setting is deemed invalid. The validity of a second BIOS setting stored in a baseboard management control module of the server is also determined. If the second BIOS setting is valid, it is stored into the first memory. In one embodiment, the BIOS setting default is stored into the baseboard management control module when the second BIOS setting is not valid. In one embodiment, a verification value of the BIOS setting default is further stored into the baseboard management control module.

In one embodiment, whether a flag indicating a need to modify a setting of the BIOS is set in the first memory is determined when the first BIOS setting is valid. If the flag is set, the first BIOS setting is modified and stored into the baseboard management control module. The flag is then cleared in the first memory.

In one embodiment, the BIOS obtains a first verification value of the first BIOS setting and, from the baseboard management control module, a second verification value of the second BIOS setting. When the flag is not set in the first memory, whether the first and second verification values are the same is determined. The validity of the second BIOS setting is determined when the verification values do not agree. The second BIOS setting, when valid, is stored into the first memory. In one embodiment, the first BIOS setting is instead stored into the baseboard management control module and loaded by the BIOS when the second BIOS setting is invalid. In one embodiment, the BIOS loads the first setting when the first and second verification values match.

In one embodiment, the server is restarted and the BIOS loads from the first memory the second BIOS setting stored into the first memory. In one embodiment, the first memory is a complementary metal-oxide-semiconductor (CMOS) memory chip.

In short, with a mechanism for determining the validity of the first and second BIOS settings, the BIOS may choose to load the first one from the first memory or load the second one from the baseboard management control module. The first and second BIOS settings may have verification values in some embodiments, while in others the BIOS may back up its current setting in the baseboard management control module depending on whether the second BIOS setting is valid and the existence of a flag in the first memory.

### BRIEF DESCRIPTION OF THE DRAWINGS

The present invention will become more fully understood from the detailed description given hereinbelow and the accompanying drawings which are given by way of illustration only and thus are not limitative of the present invention and wherein:

FIG. 1 is a high-level block diagram of a server, in accordance with one embodiment of the present invention.

FIG. 2 is a flowchart of a BIOS maintenance method, in accordance with one embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

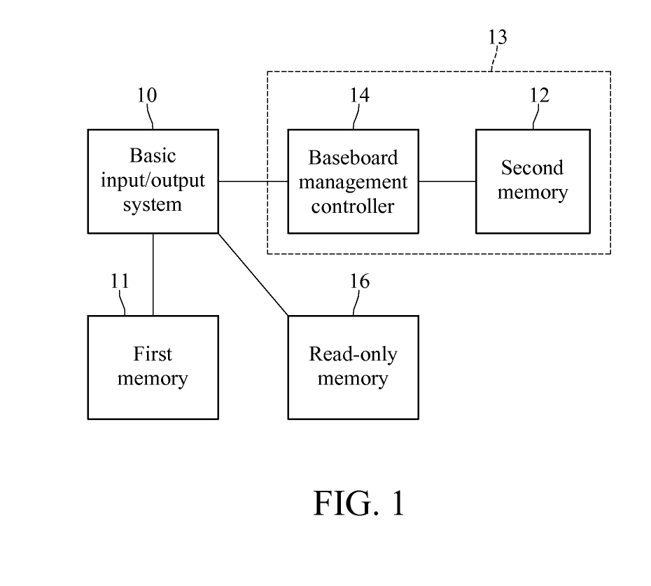

Please refer to FIG. 1. As shown in this high-level block diagram, in one embodiment, a server 1 comprises a BIOS (basic input/output system) 10, a first memory 11, a baseboard management control module 13, and a read-only memory (ROM) 16. The baseboard management control module 13 includes a baseboard management controller (BMC) 14 and a second memory 12. The coupling between the BIOS 10 and the BMC 14 may be, but not limited to, a LPC (Low Pin Count) bus. The first memory 11 and the ROM 16 are coupled to the BIOS 10. To streamline the description, the CPU, volatile random-access memory used by the CPU (e.g. a dual in-line memory module or DIMM), heat-dissipation modules, power supply, hard disk drives, RAID (redundant array of independent disks) card, sensors for the aforementioned hardware, etc that the server 1 may further include are not depicted in FIG. 1.

As the processing core of the IPMI, the BMC 14 monitors sensors at multiple locations within the server 1 to get a handle of and automatically report the temperature, power stability, and other operational status of the server 1. The BMC 14 may also cause the server 1 to start up or shut down. The server 1 can be started up in other ways; for example, it can be started up by pressing a power button on a motherboard thereof. The second memory 12 is non-volatile and may be coupled with the BMC 14 on an I²C (Inter-Integrated Circuit) or a SPI (Serial Peripheral Interface) bus. In this embodiment, the second memory 12, serving as the storage unit of the baseboard management control module 13, is adapted for storing the second BIOS setting. The first memory 11 and the second memory 12 may be flash memory, other types of electrically erasable programmable read-only memory (EEPROM), or other non-volatile storage. In one embodiment, the first memory 11 is a volatile CMOS memory chip equipped with a battery and dedicated to the storage of a BIOS setting.

The operation of the BIOS 10 involves the CPU and a dedicated read-only memory 16 storing the machine code that the CPU first reads according to its program counter when the server 1 is powered on. The CPU is bestowed with the capabilities of the BIOS 10 by executing this machine code. Generally speaking, the BIOS 10 can be seen as a complete and independent function block.

Please note that in one embodiment, any access to the first or second BIOS setting or the setting default includes taking the setting as a bit string and calculating a verification value thereof so as to verify the correctness and authenticity of the bits. The verification value may be a simple checksum or a hash value, such as the outcome of a function of the CRC (cyclic redundancy check) series. The calculation of verification values is regarded by the present invention as inherent to the accessing to the settings of the BIOS 10 and may be performed by the BIOS 10, the BMC 14, or other circuitry on the motherboard. Moreover, in one embodiment, each of the first memory 11, the second memory 12, and the ROM 16 maintains for the setting it stores a validity mark indicating that the setting is valid or affirming that the storage of the setting is effectively completed, for any access to the first or second BIOS setting or the setting default might be abnormally terminated as a result of, say, an incomplete access command or the baseboard management control module 13 losing power.

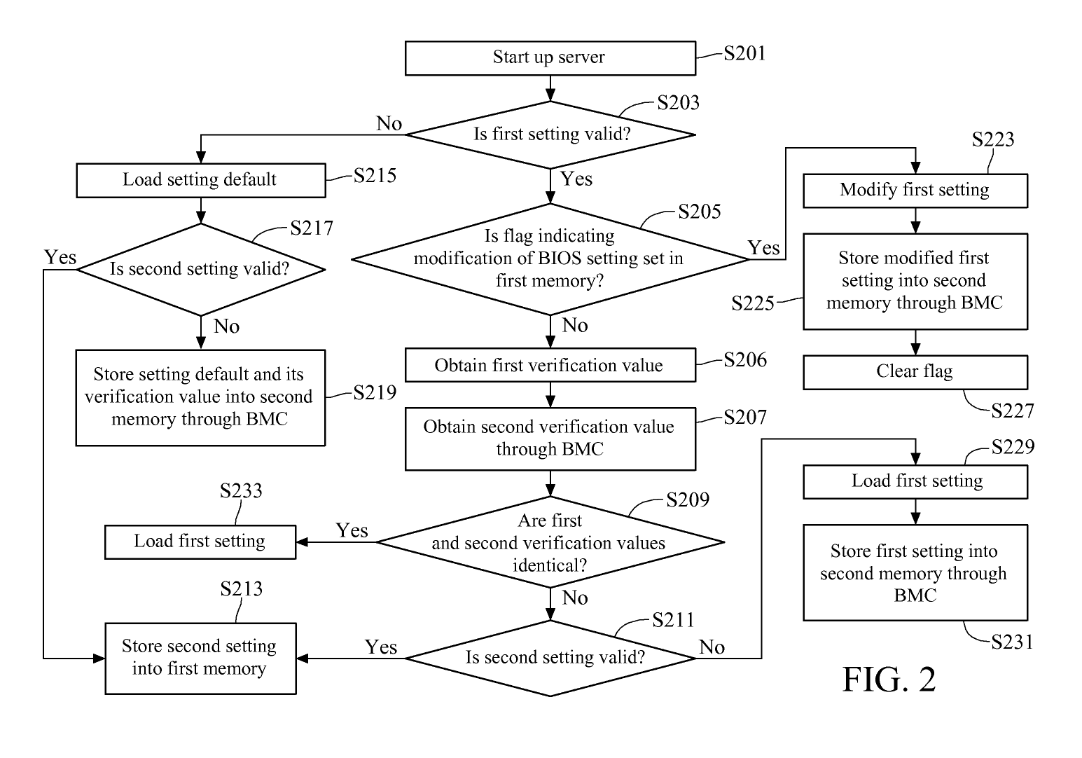

Please refer to FIG. 2 with regard to FIG. 1. As shown in this flowchart, the server 1 is turned on in step S201. In step S203, the BIOS 10 determines whether the first BIOS setting is valid. If it is, step S205 is executed. If it is not, the BIOS 10 loads the BIOS setting default in step S215. Specifically, step S215 may include the BIOS 10 introducing the setting default to the first memory 11 and then loading it thence. In step S217 the BIOS 10 further determines (through the BMC 14) whether the second BIOS setting stored in the second memory 12 is valid. If it is not, then in step S219 the BIOS 10 calculates the verification value of the setting default and stores both the verification value and the setting default into the baseboard management control module 13, particularly in the second memory 12, where the setting default replaces the second BIOS setting that was originally there. If the second BIOS setting is deemed valid in step S217, the BIOS 10 obtains it through the BMC 14 and stores it into the first memory 11 in step S213, replacing the setting default that was loaded into the first memory 11 in step S215. Hereafter, the BIOS 10 loads the second BIOS setting and continues initializing other components of the server 1.

In step S205, the BIOS 10 determines whether a flag indicating that its setting should be modified is set in the first memory 11. The flag may be set by the user interface of the BIOS 10 or a utility program in the operating system capable of accessing the BIOS 10 in response to an external command, indicating a need to modify the BIOS setting in the first memory 11. Modification and reposition of the first BIOS setting in the first memory 11 is carried out through the BIOS 10, e.g. through the BIOS setup interface, in step S223. In step S225, the BIOS 10 stores the modified first setting into the baseboard management control module 13, specifically into the second memory 12 through the BMC 14, the modified first setting replacing the second setting that was originally in the second memory 12. The BIOS 10 then clears the flag in step S227, the user interface or the utility program accordingly getting back to its user.

If the first BIOS setting is valid and the flag is not set, the BIOS 10 obtains a first verification value of the first BIOS setting in the first memory 11 in step S206; the obtainment may involve the BIOS 10 calculating the first verification value itself In step S207 the BIOS 10 also obtains a second verification value of the second BIOS setting in the baseboard management control module 13, particularly in the second memory 12 through the BMC 14. The BIOS 10 then determines in step S209 whether the first and second BIOS settings are identical based on whether the first and second verification values are the same. If they are, no change or anomaly is detected in the server 1, and the BIOS 10 follows the regular bootstrapping procedure, loading the first BIOS setting from the first memory 11 in step S233. If the settings are not identical, then in step S211 the BIOS 10 further determines (through the BMC 14) whether the second BIOS setting in the second memory is valid. Steps S211 and S217 are similar. The BIOS 10 executes step S213 if the second setting is valid, replacing the first setting in the first memory 11 with the second. If the second setting is invalid, the BIOS 10 loads the first BIOS setting from the first memory 11 in step S229 and in step S231 stores it into the baseboard management control module 13, specifically into the second memory 12 through the BMC 14 as the second BIOS setting.

In one embodiment, the baseboard management control module 13 maintains in the second memory 12 a parameter mapping indicating which parameter of the second BIOS setting is stored in which sub-block of the second memory 12. In particular, the BMC 14 may dedicate a block in the second memory 12 to the storage of the second BIOS setting, while the parameter mapping describes which bytes within this block are associated with a certain parameter of some hardware, in addition to the possible values of that parameter. When the number of parameters in the first BIOS setting or the setting default differs from that in the second setting due to a machine code update of the BIOS 10, the existence of such mapping helps the BIOS 10 seamlessly access the backup values of common parameters through the BMC 14.

To summarize, with a mechanism for determining the validity of the first and second BIOS settings, the BIOS may choose to load the first one from the first memory or load the second one from the baseboard management control module. The first and second BIOS settings may have verification values in some embodiments, while in others the BIOS may back up its current setting in the baseboard management control module depending on whether the second BIOS setting is valid and the existence of a flag in the first memory. By involving the baseboard management control module of the IPMI in the maintenance of the BIOS, the latter is able to acquire backup, restore to default, or execute normally through a series of decisions in the face of active or passive alteration to the BIOS and its setting during the operation of the server.

What is claimed is:

1. A BIOS (basic input/output system) maintenance method comprising:
starting up a server;
determining whether a first BIOS setting stored in a first memory of the server is valid;
loading, by a BIOS of the server, a BIOS setting default when the first BIOS setting is not valid;
determining whether a second BIOS setting stored in a baseboard management control module of the server is valid; and
storing the second BIOS setting into the first memory when the second BIOS setting is valid.

2. The BIOS maintenance method of claim 1, further comprising:
determining whether a flag indicating a need to modify a setting of the BIOS is set in the first memory when the first BIOS setting is valid;
modifying the first BIOS setting when the flag is set in the first memory; and
storing the modified first BIOS setting into the baseboard management control module and clearing the flag in the first memory.

3. The BIOS maintenance method of claim 2, further comprising:
obtaining, by the BIOS, a first verification value of the first BIOS setting;
obtaining, by the BIOS, a second verification value of the second BIOS setting from the baseboard management control module;
determining whether the first verification value is the same as the second verification value when the flag is not set in the first memory;
determining whether the second BIOS setting is valid when the first verification value is not the same as the second verification value; and
storing the second BIOS setting into the first memory when the second BIOS setting is valid.

4. The BIOS maintenance method of claim 3, further comprising:
storing the first BIOS setting into the baseboard management control module when the second BIOS setting is not valid.

5. The BIOS maintenance method of claim 4, further comprising:
loading, by the BIOS, the first BIOS setting when the second BIOS setting is not valid.

6. The BIOS maintenance method of claim 3, further comprising:
loading, by the BIOS, the first BIOS setting when the first verification value is the same as the second verification value.

7. The BIOS maintenance method of claim 3, further comprising:
restarting the server; and
loading, by the BIOS from the first memory, the second BIOS setting stored into the first memory.

8. The BIOS maintenance method of claim 1, further comprising:
restarting the server; and
loading, by the BIOS from the first memory, the second BIOS setting stored into the first memory.

9. The BIOS maintenance method of claim 1, further comprising:
storing the BIOS setting default into the baseboard management control module when the second BIOS setting is not valid.

10. The BIOS maintenance method of claim 9, further comprising:
storing a verification value of the BIOS setting default into the baseboard management control module.

11. The BIOS maintenance method of claim 1, wherein the first memory is a complementary metal-oxide-semiconductor memory chip.
